(19) United States
(12) Patent Application Publication
(10) Pub. No.: US 2024/0364049 A1
(43) Pub. Date: Oct. 31, 2024

(54) ELECTRICAL POWER CONNECTOR AND MANUFACTURING METHOD THEREOF

(71) Applicant: SCOLMORE (INTERNATIONAL) LIMITED, Tamworth, Staffordshire (GB)

(72) Inventor: Ross TURNER, Leicester, Leicestershire (GB)

(21) Appl. No.: 18/687,489

(22) PCT Filed: Aug. 30, 2022
(86) PCT No.: PCT/GB2022/000073

§ 371 Date: Feb. 28, 2024

(30) Foreign Application Priority Data
Aug. 31, 2021 (GB) 2112405.2
Sep. 8, 2021 (GB) 2112769.1

(51) Int. Cl. H01R 13/627; H01R 13/635; H01R 13/639; H01R 13/652; H01R 103/00

(52) U.S. Cl. CPC H01R 13/6273; H01R 13/639; H01R 13/652; H01R 13/635; H01R 2103/00

(57) ABSTRACT

An electrical power connector includes a housing for electrical terminals each for engaging with a respective receiving terminal of an electrical socket. The housing includes two oppositely positioned side wall sections and two spacer wall sections maintaining the side wall sections spaced apart, each side wall section and at least one spacer wall section including a locking member resiliently biased to reside in a first position spaced from adjacent regions of a respective housing wall section and which is deflectable to a second position, each locking member including a first region having an abutment face and a second region facilitating deflection of the locking member and abutment from the first position to the second position, and each abutment face being positioned nearer than the second region to that end of the connector housing that in use confronts an electrical socket at which the terminals of the connector are received.

### CROSS-REFERENCE TO RELATED APPLICATIONS

This application is the US national stage of PCT/GB2022/000073, filed Aug. 30, 2022 and designating the United States, which claims the priority of GB 2112405.2, filed Aug. 31, 2021, and the priority of GB 2112769.1, filed Sep. 8, 2021. The entire contents of each foregoing application are incorporated herein by reference.

### BACKGROUND OF THE INVENTION

### Field of the Invention

This invention relates to an electrical power connector of the type comprising means for interlocking with a socket thereby to prevent or inhibit separation of the connector and socket.

The invention relates in particular, but not exclusively, to an electrical power connector of the type comprising a housing which extends around a plurality of connector terminals with a part of the housing extending, in use, around part of a socket with which the connector is positioned in electrical contact. Thus the invention may be employed in a power connector that is in accordance with the International Standard IEC60320 and which comprises an earth terminal.

### Description of the Related Art

Proposals for inhibiting unintended separation of a power connector from a socket include the use of a locking blade which engages and locks with a pin as described in EP 1459412. Although that locking blade type of design is very effective for inhibiting unintended separation it is difficult to modify the known design to significantly reduce manufacturing and assembly costs.

The present invention seeks to provide an improved electrical power connector of the type comprising locking means for interlocking with a socket.

### SUMMARY OF THE INVENTION

In accordance with the present invention there is provided an electrical power connector comprising an insulated housing which supports and contains a plurality of electrical terminals each for engaging with a respective receiving terminal of an electrical socket and wherein:
the housing comprises two oppositely positioned side wall sections and two spacer wall sections which maintain said side wall sections spaced apart,
each of said side wall sections and at least one of said spacer wall sections comprising a locking member which is resiliently biased to reside in a first position and which is deflectable to a second position,
each said locking member comprising a first region provided with an abutment face and a second region which facilitates deflection of the locking member and abutment from the first position to the second position,
each said locking member abutment face being positioned nearer than said second region to that end of the connector housing that in use confronts an electrical socket at which the terminals of the connector are received, and
each said locking member abutment face residing spaced from adjacent regions of a respective housing wall section when the locking member is in the first position and said abutment face residing closer to said adjacent wall section when the locking member is in the second position.

The invention provides also the combination of an electrical power connector and a socket wherein the connector is of a type in accordance with the present invention. There is provided also a method of manufacture of a connector in accordance with the present invention.

The electrical connector of the invention is particularly suitable for use with a socket of a type wherein the socket comprises a housing into which an end region of the connector housing extends when the terminals of the connector are moved into engagement with the receiving terminals of the socket and wherein the socket housing defines at least one abutment face which confronts the abutment face of the locking member of the inserted connector when the locking member resides in said first position.

It is not essential that the electrical socket defines three or more abutment faces. The electrical connector of the present invention may be employed with, for example, a socket having only one or two abutment faces for engaging and locking with the abutment face(s) of an inserted connector, or may be employed with a socket devoid of any abutment faces albeit that the abutment faces of the electrical connector would not then be able to lock the connector relative to the socket. A socket having at least three abutment faces for engagement by abutment faces of the inserted connector will facilitate achieving a strength of interlock and resistance of inadvertent removal of the connector than in the case of a socket having only one or two abutment faces for engagement by the electrical connector.

Each or at least one locking member may be a component formed separately from the housing and secured to the housing.

Alternatively each or at least one locking member may be formed integrally with the housing. The locking member may be moulded integrally with the housing. The locking member and housing may be formed integrally from moulded plastics material. The locking member may be formed by moulding of the housing and then cutting or otherwise removing material of the housing, for example to create slits, thereby to form and define part of the shape of the locking member. Following cutting or otherwise removing material of the housing the locking member may be subject to a deformation action, for example by subjecting to heat, whereby the locking member subsequently inherently resides in said first position in the absence of an applied force.

Typically each or at least one locking member will be of an elongate shape. The locking member may have one end integral with or secured to the housing. The locking member may be resiliently biased inherently to reside in said first position in consequence of properties of the material from which the locking member is formed.

Alternatively separate biasing means may be provided to act on the locking member and inherently bias it to said first position.

A suitable material for forming a housing having integrally formed locking members is nylon.

The abutment face of the first region of the locking member may reside within the thickness of the wall of the housing when the locking member is in the second position. That is, the abutment face then resides beneath the outer surface of adjacent regions of a housing wall section.

Preferably the abutment face resides substantially wholly within the thickness of the housing wall when fully deflected away from the first position.

The abutment faces may be equally spaced from that end of the connector that, in use, confronts an electrical socket at which the terminals of the connector are received. Preferably the two locking members of the housing side wall sections are equally spaced from the said end of the housing. The locking member of a third wall section may have a spacing from said housing end which is different from that of one or each of the locking members of the two side wall sections.

The abutment face preferably lies in a plane perpendicular to the length of an elongate said locking member. The abutment face preferably lies at right angles to the length of the elongate locking member when the locking member is fully deflected to said second position or at an angle less that a right angle when in said deflected position such that the outer edge of the abutment face is further from the end of the housing than a region of the abutment face lying inwards of said outer edge.

The locking member(s) of elongate shape may have a distal end which is spaced further from the end face of the connector housing than the other end of the locking member, namely that end which is integral with or secured to the connector housing.

Alternatively the locking member(s) of elongate shape may have a distal end which is nearer the end face of the connector housing than the other end that is integral with or secured to the connector housing.

The connector may be of a type in accordance with International Standard IEC 60320, for example a C13 IEC Connector.

The connector may comprise two power supply terminals (such as may be termed live and neutral terminals) and an earth terminal.

If only one of said two spacer walls is provided with a locking member, preferably the earth terminal is positioned closer to the spacer wall that is devoid of a locking member than the spacing of the earth terminal from that spacer wall provided with a locking member.

### BRIEF DESCRIPTION OF THE DRAWINGS

The present invention will now be described, by way of example only, with reference to the accompanying drawings in which:

FIG. 1 is a perspective view of a connector in accordance with the present invention as viewed in a first direction;

FIG. 2 is a perspective view of the connector of FIG. 1 as viewed in a second direction;

FIG. 3 is a plan view of the connector of FIG. 1;

FIG. 4 is a side view of the connector of FIG. 1;

FIG. 5 is a perspective view of the connector of FIG. 1 as viewed in a third direction;

FIG. 6a is a perspective view of the rear of a socket for receiving the connector of FIG. 1;

FIG. 6b is a front view of the socket of FIG. 6a;

FIG. 7 is a perspective view of the connector of FIG. 1 in combination with the socket of FIG. 6, and

FIG. 8 is a longitudinal sectional view of the connector of FIG. 1 in a cross-sectional plane parallel with the plane of FIG. 4.

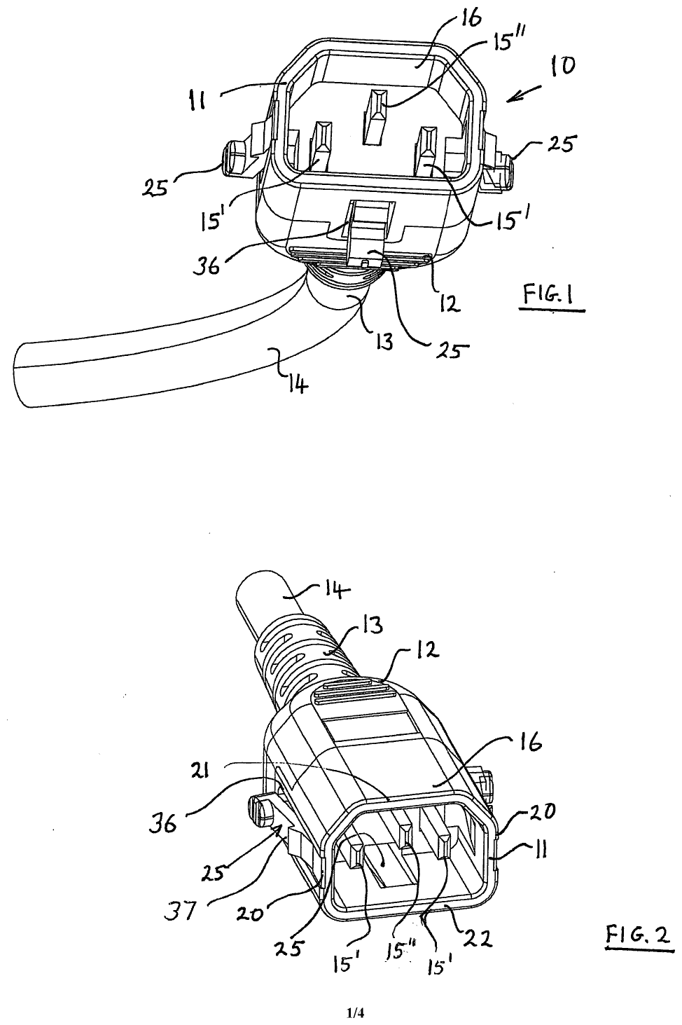

### DETAILED DESCRIPTION

An electric power connector 10 in accordance with International Standard IEC 60320 comprises a housing 11 of a moulded plastics material such as nylon.

One end region 12 of the housing is moulded integrally with a cable inlet guide 13 for a cable 14.

The housing 11 contains and provides support for three brass terminal pins 15′, 15″. One terminal 15″ is an earth terminal and the other two terminals 15′ are live and neutral power terminals. The housing extends lengthwise beyond the ends of the terminal pins 15 such that the ends of the terminal pins lie inwards from the housing end 16 opposite the end 12.

The housing is of a substantially rectangular shape comprising two side wall sections 20 and two spacer wall sections referred to now as an upper wall 21 and a lower wall 22.

Each of the side walls and the lower wall 22 comprises a locking arm 25 that is moulded integrally with the housing.

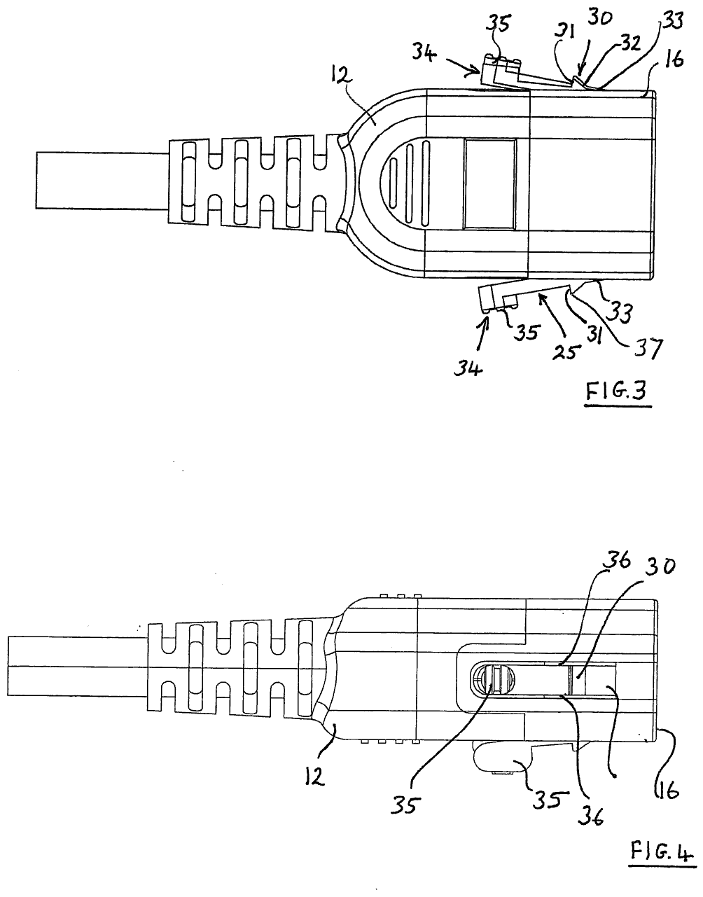

Each locking arm 25 is of an elongate rectangular shape and inherently resides in a first position (see FIG. 3) at which it is angled outwards to increase in spacing from the surrounding regions of the respective wall section as considered in a direction away from the housing end 16 to the cable entry end 12.

Again referring to FIG. 3, each locking arm 25 comprises a locking protrusion 30 which defines an abutment face 31 and a cam face 32. The protrusion 30 is formed near to but spaced from the end 33 of the locking arm that is integral with the housing.

The other, distal end 34 of the locking arm is formed with a textured tab 35 which facilitates manual application of pressure to counter the inherent resiliency of the locking arm and move it inwards toward the housing thereby to lie substantially wholly within the recess 36 of the housing, the locking protrusion then also lying closer to adjacent regions of the housing wall.

The abutment face 31 lies in a plane perpendicular or at less than 90 degrees relative to the outer face of the housing such that the outer edge 37 of the abutment face is no further from the tab 35 than the adjacent region of the abutment face.

In this embodiment the abutment face 31 of the three locking members are equally spaced from the end 16 of the housing.

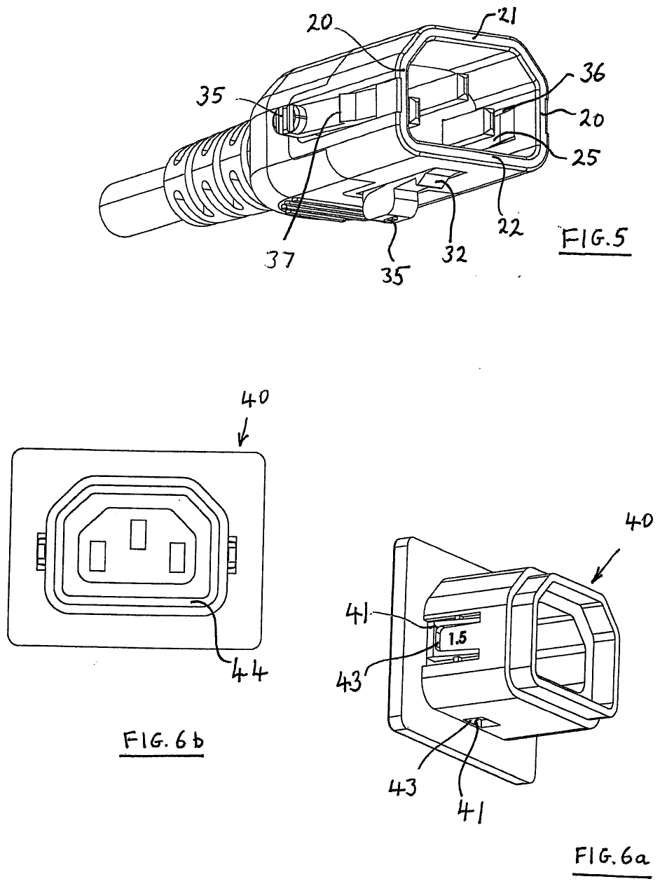

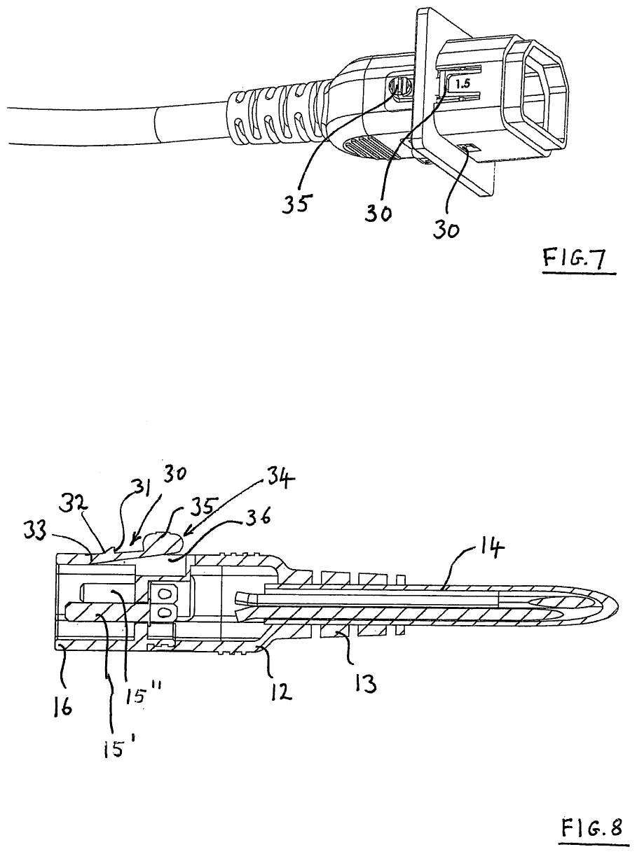

A socket 40 for receiving the connector 10 is shown in FIGS. 6a and 6b. The socket is a nylon moulding and is formed with an annular recess (not shown) into which the end of the housing 11 is received when the terminal pins 15 are brought into contact with terminals (not shown) within the socket.

When the housing is inserted into the socket 40 the cam surfaces 32 of the locking arms initially are urged inwards to lie substantially co-planar with respective housing wall sections 20, 22 until, when the housing is fully inserted, the locking protrusions are free inherently to move outwards and locate in three recesses 41 defined by the socket walls. In that position the abutment faces 31 of the locking arm confront abutment faces 43 of the socket recesses 41 thereby to inhibit withdrawal of the connector until each of the locking arms is moved inwards towards the housing.

Having regard to the foregoing it will be understood that the three locking arms serve to act together to provide an enhanced resistance to inadvertent withdrawal of the connector from the socket.

1. An electrical power connector comprises an insulated housing which supports and contains a plurality of electrical terminals each for engaging with a respective receiving terminal of an electrical socket and wherein:
the housing comprises two oppositely positioned side wall sections and two spacer wall sections which maintain said side wall sections spaced apart,
each of said side wall sections and at least one of said spacer wall sections comprises a locking member which is resiliently biased to reside in a first position and which is deflectable to a second position,
each said locking member comprises a first region provided with an abutment face and a second region which facilitates deflection of the locking member and abutment from the first position to the second position,
each said locking member abutment face is positioned nearer than said second region to that end of the connector housing that in use confronts an electrical socket at which the terminals of the connector are received, and
each said locking member abutment face residing spaced from adjacent regions of a respective housing wall section when the locking member is in the first position and said abutment face residing closer to said adjacent wall section when the locking member is in the second position.

2. The electrical power connector according to claim 1 wherein the or at least one locking member is formed integrally with the housing.

3. The electrical power connector according to claim 2 wherein the said locking member is moulded integrally with the housing.

4. The electrical power connector according to claim 1 wherein each or at least one locking member is of an elongate shape having one end integral with or secured to the housing.

5. The electrical power connector according to claim 4 wherein each or at least one locking member comprises a distal end which is spaced further from the end face of the connector housing than the other locking member end that is integral with or secured to the connector housing.

6. The electrical power connector according to claim 4 wherein each or at least one locking member comprises a distal end which is nearer the end face of the connector housing than the other locking member end that is integral with or secured to the connector housing.

7. The electrical power connector according to claim 1 and which complies with the requirements of International Standard IEC 60320.

8. The electrical power connector according to claim 1 wherein each or at least one locking member is resiliently biased inherently to reside in said first position under the action of the material from which it is formed.

9. The electrical power connector according to claim 1 and comprising biasing means to act on at least one locking member and inherently bias that locking member to said first position.

10. The electrical power connector according to claim 1 wherein the abutment face of at least one locking member resides wholly within the thickness of the wall of the housing when the locking member is fully deflected away from said first position.

11. The electrical power connector according to claim 1 wherein the abutment face lies at right angles to the length of the elongate locking member when the locking member is fully deflected away from said first position or at an angle less that a right angle when in said deflected position such that the outer edge of the abutment face is further from the end of the housing than a region of the abutment face lying inwards of said outer edge.

12. The electrical power connector according to claim 1 wherein the connector comprises two power supply terminals and an earth terminal.

13. The electrical power connector according to claim 1 wherein only one of said two spacer walls is provided with a locking member and the earth terminal is positioned closer to the spacer wall that is devoid of a locking member than the spacing of the earth terminal from that spacer wall provided with a locking member.

14. An electrical power connector and socket combination comprising a socket and the electrical power connector according to claim 1.

15. The electrical power connector and socket combination according to claim 14 wherein the socket comprises a housing into which an end region of the connector housing extends when the terminals of the connector are moved into engagement with receiving terminals of the socket.

16. The electrical power connector and socket combination according to claim 14 wherein the socket comprises a housing which defines at least one abutment face which confronts the abutment face of a locking member of the inserted connector when the locking member resides in said first position.

17. The electrical power connector A connector and socket combination according to claim 14 wherein the electrical socket defines at least three abutment faces each for engagement by the abutment face of a respective locking member of said connector.

18. A method of manufacture of the electrical power connector according to claim 1 wherein each or at least one locking member is formed by moulding of the housing and then cutting or otherwise removing material of the housing to form the locking member.

19. The method according to claim 18 wherein the step of cutting or otherwise removing material of a housing comprises the step of forming slits thereby to form and define part of the shape of the locking member.

20. The method according to claim 19 wherein the locking member is subject to deformation action whereby it subsequently inherently resides in said first position.
